(19) United States
(12) Patent Application Publication
(10) Pub. No.: US 2020/0074009 A1
(43) Pub. Date: Mar. 5, 2020

(54) Cookie Management

(71) Applicant: International Business Machines Corporation, Armonk, NY (US)

(72) Inventors: Mauro Marzorati, Lutz, FL (US); Seda Özses, Vienna (AT); Scott Moonen, Fuquay Varina, NC (US); Yaser K. Doleh, North Royalton, OH (US)

(21) Appl. No.: 16/116,632

(22) Filed: Aug. 29, 2018

(51) Int. Cl. G06F 17/30; H04L 29/08

(52) U.S. Cl. CPC G06F 17/30876; H04L 67/02; H04L 67/32; H04L 67/146

(57) ABSTRACT

A client including: a processor to implement a browser; a network interface; and a cookie manager to reduce transmission bandwidth, wherein prior to transmitting a request to a Uniform Resource Identifier (URI), the browser to use the cookie manager to access a list of cookies used by the URI to prepare a response and to remove from the request to the URI any cookies not on the list.

### BACKGROUND

This specification relates to the area of cookie management. Specifically, this specification relates to control of the cookies provided to servers when requesting content so as to reduce the load on the server and/or network.

### SUMMARIES

This specification describes a client including: a processor to implement a browser; a network interface; and a cookie manager to reduce transmission bandwidth, wherein prior to transmitting a request to a Uniform Resource Identifier (URI), the browser to use the cookie manager to access a list of cookies used by the URI to prepare the a response and to remove from the request to the URI any cookies not on the list.

This specification describes a computer program product for reducing load, the computer program product including: a computer readable storage medium having stored thereon: first program instructions executable by a processor to cause the processor to generate a report of cookies used by a server when preparing a response to a request from a client; and second program instructions executable by the processor to cause the device to transmit the report with the response to the client.

This specification describes a method of managing cookies to reduce transmission bandwidth, the method including, by a processor having an associated memory: receiving a request from a client for a Uniform Resource Identifier (URI); consulting a cookie manager to determine cookies used by the URI; identifying a consent type for cookies used by the URI; retrieving a policy of allowed consent types for cookies; modifying the request to remove cookies not used by the URI; modifying the request to remove cookies with a consent type not allowed by the policy; and transmitting the modified request to a server.

### BRIEF DESCRIPTION OF THE DRAWINGS

FIG. 1 depicts a client to reduce load in an example of principles described herein.

FIG. 2 depicts a client to reduce load in an example of principles described herein.

FIG. 3 depicts a computer program product according to an example of the principles described herein.

FIG. 4 depicts a computer program product according to an example of the principles described herein.

FIG. 5 depicts a flowchart of a method of managing cookies to reduce use of server bandwidth according to an example of principles described herein.

### DETAILED DESCRIPTION

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the uses computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart, illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

An HTTP cookie (also called web cookie, Internet cookie, browser cookie, and/or simply cookie) is a small piece of data sent from a website and stored on the user's computer by the user's web browser while the user is browsing. Cookies may be stored long term on a users' device. Cookies may include session cookies which are not retained outside the browser session. Cookies may be formatted as a tuple. Cookies may be formatted as {name}={value}, where name is associated with a site and/or resource and value is a reference provided to identify the user and/or customize the content provided by the resource. A cookie may include attributes with associated values.

Cookies may be used in session management. In this example, a site generates a session identifier for the browser to provide with subsequent requests. This allows the site to provide the customized response sought by the user, for example, by keeping the user's “shopping cart” stable as a user peruses a site. A session identifier can work without the user “logging in” to the site.

Cookies have other uses as well. Cookies may be tracked for marketing purposes, for example, a site may review all the cookies provided by a user to determine other content used by the user. A site may use the other cookies to profile the user. A cookie may be used to track a user across a number of domains and/or sites in order to profile a user. Accordingly, cookies may leak information about the user and represent a privacy concern.

As used in the present specification and in the appended claims, the term “a number of” or similar language is meant to be understood broadly as any positive number including 1 to infinity.

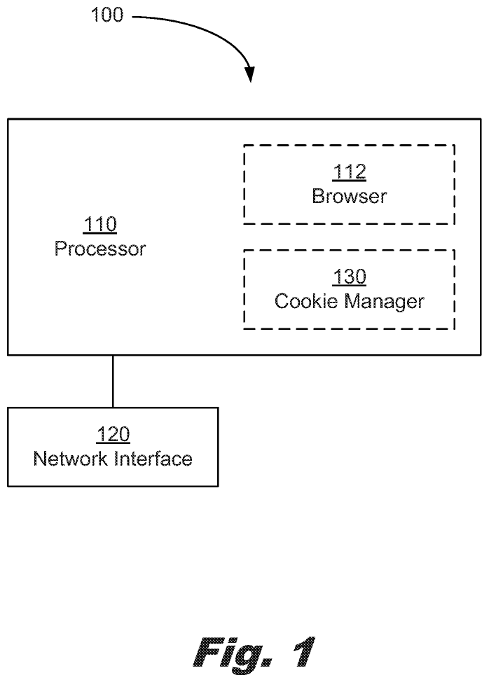

Turning now to the figures, FIG. 1 depicts a client (100) to reduce load in an example of principles described herein. The client (100) including: a processor (110) to implement a browser (112); a network interface (120); and a cookie manager (130) to reduce transmission bandwidth, wherein prior to transmitting a request (132) to a Uniform Resource identifier (URI), the browser (112) to use the cookie manager (130) to access a list of cookies (134) used by the URI to prepare a response (136) and to remove from the request (132) to the URI any cookies not on the list (134).

The client (100) may be a thick client (100), a thin client (100), and/or a hybrid client (100). The client (100) may be implemented on a workstation. The client (100) includes a processor (110). The client (100) may include multiple processors (110), either as a multiple core implementation and/or on multiple devices. The client (100) may be a proxy for an end client, where the proxy forwards a response from the URI to the end client. The client (100) may be an end client.

The processor (110) may include the hardware architecture to retrieve executable code from a data storage device and execute the executable code. The executable code may, when executed by the processor (110), cause the processor (110) to use the cookie manager (130) to access a list of cookies (134) and to remove from a URI request (132) cookies not on the list. The functionality of the computing device is in accordance to the methods of the present specification described herein. In the course of executing code, the processor (110) may receive input from and provide output to a number of hardware units.

The data storage device may store data such as executable program code that is executed by the processor (110) and/or other processing device. The data storage device may specifically store computer code representing a number of applications that the processor executes to implement at least the functionality described herein. These applications may include a browser (112) and/or a cookie manager (130).

The data storage device may include various types of memory modules, including volatile and nonvolatile memory. For example, the data storage device of the may include Random Access Memory (RAM), Read Only Memory (ROM), and/or Hard Disk Drive (HDD) memory. Other types of memory may also be utilized, and the present specification contemplates the use of many varying type(s) of memory in the data storage device as may suit a particular application of the principles described herein. In certain examples, different types of memory in the data storage device may be used for different data storage needs. For example, in certain examples the processor (110) may boot from Read. Only Memory (ROM), maintain nonvolatile storage in the Hard Disk Drive (HDD) memory, and execute program code stored in Random Access Memory (RAM).

The data storage device may include a computer readable medium, a computer readable storage medium, or a non-transitory computer readable medium, among others. For example, the data storage device may be, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM) read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store computer usable program code for use by or in connection with an instruction execution system, apparatus, or device. In another example, a computer readable storage medium may be any non-transitory medium that can contain, or store a program for use by or in connection with an instruction execution system, apparatus, or device. The data storage device may contain the list of cookies (134).

The browser (112) performs activities such as requesting a URI. For example, the browser (112) may display a requested website. In doing so, the browser (112) may request an updated version of the website from the URI. The request includes a number of cookies. These cookies are provided with every request (132) for the URI. However, many of the cookies provided are not used in preparing the response (136). Accordingly, they are extra data that does not provide value while consuming bandwidth and resources.

The network interface (120) provides a connection to access the URI. The request (132) is provided to the network interface (120) and the response (136) is received from the network interface. These transfers may be direct and/or indirect. A network interface (120) may be a connection to a local network and/or an external network. In an example, the network interface (120) is to an organization's internal network, e.g., an intranet. The network interface (120) may connect to the Internet.

The cookie manager (130) accesses the list of cookies (134). The cookie manager (130) may provide additional functionality, such as: reviewing current cookies, identifying unwanted cookies, identifying tracking cookies, categorizing cookies by purpose, monitoring aging of cookies, removing stale cookies from the list of cookies (134), etc. The cookie manager may remove data from the list of cookies (134) after an expiration period.

The cookie manager (130) may operate without visibility to a user. In an example, the cookie manager (130) operates at an intermediate between the browser (112) and the URI.

The request (132) may be generated by the browser (112). The request may be received by the client (100) from another source. In an example, the client (100) is an intermediate between an end client and the URI. The client (100) may be an end client (100). The request (132) includes a requested resource from the URI. The request includes a number of cookies being provided with the request (132) to a server supporting the URI. The cookie manager (130) reviews the usage of the cookies in generating a response (136) and removes cookies not used in generating the response (136). This reduces the size of the request (132). This reduces the load on the server associated with the URI. This may also reduce the load on the network. This activity may be performed by the client (100) generating the request (132). This activity may be performed by an intermediate client (100) between the end client and the server. In an example, this activity is performed by a router and/or similar device which also functions as the network interface (120).

The list of cookies used (134) is a list of cookies used by URIs to prepare responses when a request is made to the URI. The list of cookies (134) may be a list of {name}={value} statements. The list of cookies (134) may be a list of {name} statements without storing the values. This may provide a security benefit when a single list of cookies (134) is used to support multiple clients, accounts, and/or users. The list of cookies (134) may include attributes with and/or without associated values. For example, the list of cookies (134) may include an expiration date. In an example, the cookie manager (130) modifies the expiration date based on usage of the associated cookie. The list of cookies used (134) may be a list, a database, a data structure, a set of values, and/or some other suitable implementation.

The response (136) is received by the client (100) and contains the content requested from the URI. The response (136) may contain a report of cookies used to prepare the response (136). The cookie manger (130) may use the report to update the list of cookies (134). The cookie manager (130) may add new cookies to the list of cookies (134). The cookie manager (130) may review the list of cookies for duplicate and/or overlapping cookies.

The cookie manager (130) improves functioning of the network environment including the server providing the URI. The cookie manager (130) does this by reducing the size of messages provided to the network access (120) to be transmitted. This reduces the load on the components of the network which pass along the request (132) by trimming unused and/or unneeded cookies from the request (132). Because these cookies are not used for preparation of the response (136), removing them from the request (132) does not change the result of the process but does reduce the amount of data that is transmitted through the network and received at the server. This approach uses the processing power of the processor (110) implementing the cookie manager to reduce network and/or server load without impacting performance. In some examples, the implementation of the cookie manager (130) happens outside the view of a user so that it does not place any additional activity on the user. In some examples, the cookie manager (130) may be accessed and/or modified by the user but performs most activities automatically, again to limit the impact on the user. The cookie manager (130) may include settings set by a network administrator or user to share the list of used cookies (134) across an organization and/or multiple computers. Similarly, as discussed below, the cookie manager (130) may operate on a network intermediate, for example, a network access point (120).

The client (100) may receive a report from a URI listing which cookies were used by the URI in answering a request (132) from the browser (112), the cookie manager (130) may modify a corresponding list of cookies (134) used by that URI based on the report from that URI.

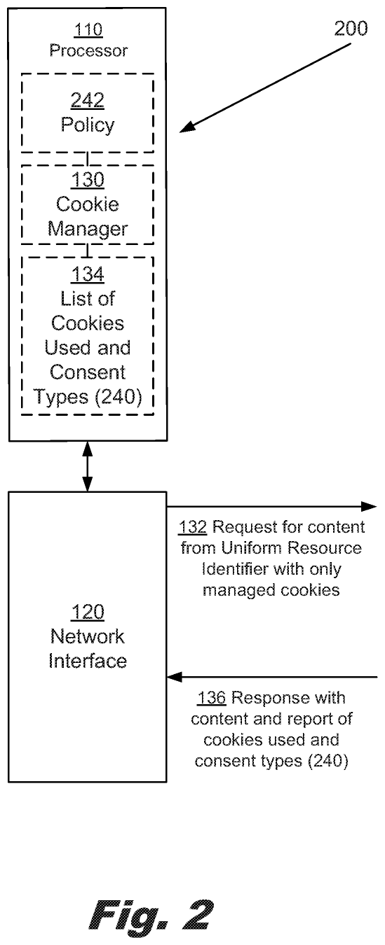

FIG. 2 depicts a client (200) to reduce load in an example of principles described herein. The client (200) including: a processor (110) to implement a browser (112); a network interface (120); and a cookie manager (130) to reduce transmission bandwidth, wherein prior to transmitting a request (132) to a Uniform Resource Identifier (URI), the browser (112) to use the cookie manager (130) to: access a list of cookies (134) used by the URI to prepare a response (136), access the consent types (240) for the cookies on the list of cookies (134); receive a policy (242) indicating authorized consent types (240) for cookies; remove from the request (132) to the URI any cookies not on the list (134); and remove from the request (132) to the URI any cookies without a consent type (240) authorized by the policy (242).

In this example, the list of cookies (134) includes a number of consent types (240) for each cookie. The consent type (240) may be provided in a previous report associated with and/or in a response from a URI. The consent types (240) indicate the reason the associated cookie was used in preparing the response. The consent types may be based on the European Union's (EU) General Data Protection Regulation (GDPR) privacy consent types, such as: required, personalization, marketing, etc.

The policy (242) stores the authorization for allowed and/or disallowed types of consent types (240) for cookies. The policy (242) may be adjustable by a user. The policy (242) may be adjustable by consent type (240). The policy (242) may be adjusted by security categories which are mapped to the consent types (240). In an example, the cookie manager (130) consults a policy (242) of authorized consent types (240) when determining which cookies to provide with the request (132). The cookie manager (130) may allow only cookies with an authorized consent type (240). The cookie manager (130) may remove cookies with an unauthorized consent type (240). The cookie manager (130) may remove cookies with an unauthorized consent type (240) unless the cookie also has an authorized consent type (240). The cookie manager (130) may always allow cookies with a “required” consent type. A cookie may be limited to a single consent type (240). A cookie may be allowed to have multiple consent types (240).

In FIG. 2 the policy (242) is shown as separate from the cookie manager (130). The policy (242) may be implemented and/or stored as part of the cookie manager (130). The policy (242) may be implemented and/or stored as part of the list of cookies used (134). In an example, the policy is stored as a header on the list of cookies use (134).

The response (136) may include the consent types of the cookies used to prepare the response (136) in the report. The report may be used to provide and/or update the list of cookies. The list of cookies (134) may include an “unknown” consent type that is used until the specific uses by the URI are determined. Cookies with the “unknown” consent type may be allowed or not allowed as determined by the policy (242).

The cookies provided as part of the request (132) may be filtered as part of forming the request (132). The cookies may be filtered after forming the request (132). For example, an intermediate processor (110) between an end client creating the request (132) and the server filling the request (132) may implement the cookie manager (130). In this example, the intermediate processor (110) receives a request (132) with a number of cookies and provides a request (132) with a managed group cookies. The managed group of cookies may contain only the cookies used by the URI to prepare the response (136). The managed group of cookies may contain only the cookies used by the URI to prepare the response that have a consent type (240) authorized by the policy (242).

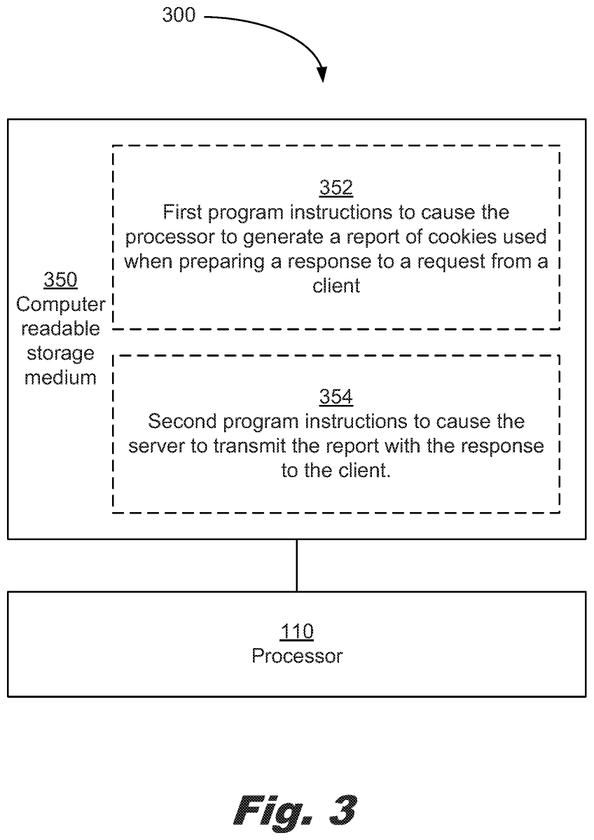

FIG. 3 depicts a computer program product (300) for reducing load, the computer program product (300) including a computer readable storage medium (350) having stored thereon: first program instructions (352) executable by a processor (110) to cause the processor (110) to generate a report of cookies used when preparing a response (136) to a request (132) from a client (100); and second program instructions (354) executable by the processor (110) to cause the server to transmit the report with the response (136) to the client (100).

The computer readable storage medium (350), as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. A computer readable storage medium (350) may include:

The processor (110) in the implementation may be the server. The processor (110) may be a secondary processor (110) to support the server. The processor (110) may be connected to a network interface (120).

The first program instructions (352) are executable by a processor (110) to cause the processor (110) to generate a report of cookies used when preparing a response (136) to a request (132) from a client (100). The request (132) is a request for content from the server. The request (132) may include an identifier to indicate a cookie manager (130) is being used. In an example, the response (136) provided when the request (132) includes the identifier includes the cookies used to prepare the response (136), while when the identifier is not present in the request; the cookie information may be omitted from the response (136). Similarly, a second indicator may be used to signal the use of a cookie manger (130) and the use of cookie filtering based on consent levels (240) of cookies as described in a policy (242). In an example, the indicator is a text phrase provided at the end of the list of cookies provided with a request (132). The indicator may be formatted as a cookie so as to not disrupt systems and/or servers that are not compatible with the cookie manager (130).

The second program instructions (354) executable by the processor (110) to cause the server to transmit the report with the response (136) to the client (100). in an example, the report is transmitted as metadata associated with the content provided in the response (136).

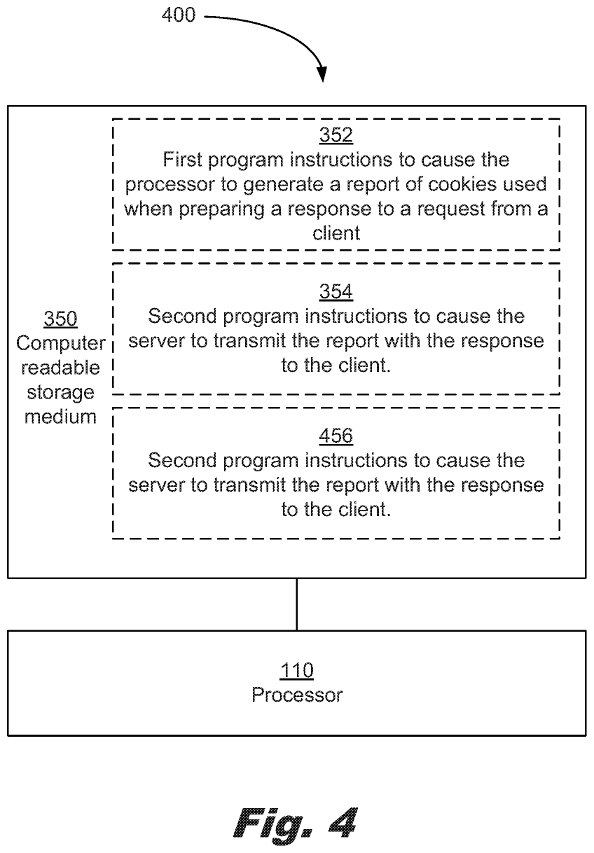

FIG. 4 depicts a depicts a computer program product (400) for reducing load, the computer program product (400) including a computer readable storage medium (350) having stored thereon: first program instructions (352) executable by a processor (110) to cause the processor (110) to generate a report of cookies used when preparing a response (136) to a request (132) from a client (100); second program instructions (354) executable by the processor (110) to cause the server to transmit the report with the response (136) to the client (100); and third program instructions (456) to identify an indicator in the request (132) from the client (100) indicting use of a cookie manager (130).

The third program instructions (456) identify an indicator in the request (132) from the client (100) indicting use of a cookie manager (130). The indicator may be text. The indicator may be a header. The indicator may be formatted as a cookie.

The indicator may cause the preparation and inclusion of the report containing the cookies used information in the response (136). The indicator may provide indication on the formatting and/or data to include in the report. In some examples, the indicator is formatted as a cookie to improve backwards compatibility.

The indicator may be provided with each request (132) from the client (100). In other examples, the indicator may be provided every second, third, etc. request (132) to reduce the preparation and transmission of the report as part of the response (136). The indicator may be provided with the first request (132) in a session and not repeated during the session. The indicator may be then repeated with the first request (132) of a subsequent session. A report may be provided in a later response that uses a different set of cookies than an original response in a session. For example, assume the first response uses cookies A and B. The next several responses use only cookies A and/or B and so no additional report is provided with those responses. A subsequent response in the same session uses cookies A, B, and C and the response includes a report updating the cookies used to A, B, and C. In another example, the updated report is provided when the consent level (240) of a cookie used to prepare the response (136) changes. Providing reports in a session only when they contain changes may further reduce the load on the server. Providing reports in a session only when they contain changes may further reduce load on the network.

In an example, the indicator in the request (132) designates inclusion or non-inclusion of the report in the response (136). For example, the indicator indicates: Report, No Report, Report New Information, Report with consent levels (240), etc. The inclusion of the indicator in a format of a cookie allows backwards compatibility with existing systems. In an example, the indictor may be formatted as {cookie manager identifier}={indicator}.

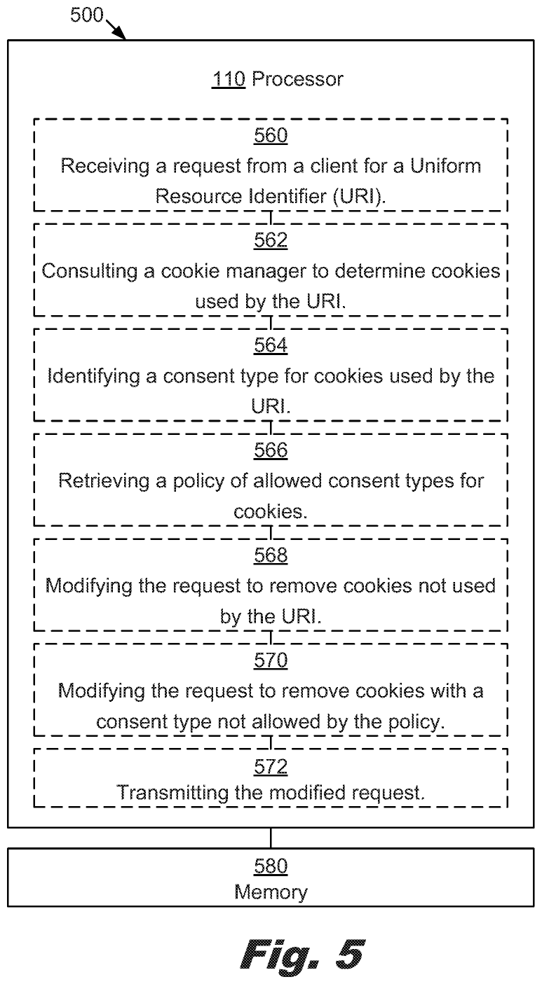

FIG. 5 depicts a flowchart of a method (500) of managing cookies to reduce use of server bandwidth according to an example of principles described herein. The method (500) is performed by a processor (110) having an associated memory (580). The method (500) includes: receiving a request (132) from a client (100) for a Uniform Resource Identifier (URI) (560); consulting a cookie manager (130) to determine cookies used by the URI (562); identifying a consent type (240) for cookies used by the URI (564); retrieving a policy (242) of allowed consent types (240) for cookies (566); modifying the request (132) to remove cookies not used by the URI (568); modifying the request (132) to remove cookies with a consent type (240) not allowed by the policy (242) (570); and transmitting the modified request (132) to a server (572).

The method (500) includes receiving a request (132) from a client (100) for a Uniform Resource Identifier (URI) (560). The client (100) may operate on the same processor (110) performing the method (500). The request (132) may be received through a network interface (120). The request (132) includes a request for content from the URI and a listing of cookies. The listing of cookies may include cookies not used by the URI to provide the requested content. These unused cookies represent additional traffic to the server supporting the URI.

The method (500) includes consulting a cookie manager (130) to determine cookies used by the URI (562). The cookie manager (130) maintains a list of cookies used by various URI. The cookie manager may store this list as a list, a database, a data structure, a lookup table, and/or in another suitable format.

The method (500) includes identifying a consent type (240) for cookies used by the URI (564). In an example, the cookie manager (130) maintains a list of consent types for cookies used by the URI. This may be in the same list of cookies by URI.

The method (500) includes retrieving a policy (242) of allowed consent types (240) for cookies (566). The policy (242) may be stored in the cookie manager (130). The policy (242) may be stored in a separate file. The policy (132) may be provided with the request (132).

The method (500) includes modifying the request (132) to remove cookies not used by the URI (568). As discussed above, removing unused cookies reduces the amount of information sent to the supporting server, which may reduce the load on the server and increase performance. Similarly, reducing the size of the messages sent to the server may reduce network load.

The method (500) includes modifying the request (132) to remove cookies with a consent type (240) not allowed by the policy (242) (570). Removing cookies based on consent type (240) may increase the privacy of the user. Removing these cookies provides a benefit for the organization controlling the server by reducing load on their server. Removing these cookies also provides them protection against inadvertently gathering information a user has not consented to share. Some organizations may refuse to identify tracking cookies and/or marketing cookies. Similarly, other organizations may integrate their “required” cookie(s) with their tracking/marketing cookies to reduce the ability of users to opt out. The identification of the use of cookies may be provided by the using organization in the report associated with the response. However, other approaches to identifying the use of cookies may be provided. For example, the system may provide the list of cookies to a third party to identify the consent types (240) of the associated cookies. This may allow identification and removal of marketing and/or tracking cookies even without the participation of the associated URI.

The method (500) includes transmitting the modified request (132) to a server (572). The modified request (132) now does not contain the unused cookies. The modified request (132) also does not include cookies without an authorized consent type (240). Accordingly, the amount of information provided to the server is reduced compared to the unmodified request (132). This processing to prepare the modified request (132) from the unmodified request (132) may be performed by a processor other than the server and so does not increase the load on the server. The processing can be performed by the end client. The processing may be performed by an intermediary between the end client and the server. In an example, the processing is performed at a router. The router may be able to combine information from multiple accounts, users, etc. to minimize the number of reports requested from the server, increasing the effectiveness of the described method. As discussed above, the modified request (132) may provide security and/or privacy benefits over the unmodified request (132).

The method (500) may further include modifying the request (132) to indicate use of the cookie manager (130). In an example, the indication is formatted as a cookie to provide backwards compatibility. The server may ignore the indicator if the server is not programmed to provide the described report of cookies used with a response (136).

The method (500) may further include receiving a response to the request wherein the response comprises a list of cookies used to generate the response and a consent type for each cookie used to generate the response. The method (500) may further include updating a record of the cookie manager to reflect the list of cookies, including the associated consent types, used to generate the response.

The method (500) may further include receiving a modification to the policy from a user, and updating the policy based on the modification to the policy from the user. In some examples, modification of a security classification in a browser produces a modification of the policy for the user. A browser may be equipped with a button, for example, a toggle button that allows tracking to toggle between on and off. Some browsers have a Do Not Track setting and/or format which may produce a notification to the cookie manager (130) to modify the policy (242).

The method (500) may further include providing the response, including the list of cookies used to generate the response, to the client (100). The method (500) may further include providing the response (136) without the list of cookies used to generate the response, to the client (100). In this approach, the operation of the cookie manager may be invisible to the browser. This may reduce the size of the response (136) to reduce resource use. The method (500) may further include removing the list of cookies used to generate the response (136) from the response (136) but adding an indicator to the end client (100) about the presence of the cookie manager (130). This may facilitate setting settings of the cookie manager (130) and/or the policy (242) from the end client (100).

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A client comprising:
a processor to implement a browser;
a network interface; and
a cookie manager to reduce transmission bandwidth,
wherein prior to transmitting a request to a Uniform Resource Identifier (URI), the browser to use the cookie manager to access a list of cookies used by the URI to prepare a response and to remove from the request to the URI any cookies not on the list.

2. The client of claim 1, the client to receive a report from a URI listing which cookies were used by the URI in answering a request from the browser, the cookie manager to modify a corresponding list of cookies used by that URI based on the report from that URI.

3. The client of claim 1, the cookie manager to remove data from the list of cookies after an expiration period.

4. The client of claim 1, wherein the client is a proxy for an end client, the proxy to forward a response from the URI to the end client.

5. The client of claim 1, wherein the client is an end client.

6. The client of claim 1, wherein the list further indicates a consent type of cookies on the list of cookies used to prepare the response.

7. The client of claim 6, wherein the cookie manager consults a policy of user authorized consent types when determining which cookies to provide with the request.

8. A computer program product for reducing load, the computer program product comprising a computer readable storage medium having stored thereon:
first program instructions executable by a processor to cause the processor to generate a report of cookies used when preparing a response to a request from a client and
second program instructions executable by the processor to cause the server to transmit the report with the response to the client.

9. The computer program product of claim 8, wherein computer readable storage medium further having stored thereof third program instructions to identify an indicator in the request from the client indicting use of a cookie manager.

10. A method of managing cookies to reduce use of server bandwidth, the method comprising, by a processor having an associated memory:
receiving a request from a client for a Uniform Resource Identifier (URI);
consulting a cookie manager to determine cookies used by the URI;
identifying a consent type for cookies used by the URI;
retrieving a policy of allowed consent types for cookies;
modifying the request to remove cookies not used by the URI;
modifying the request to remove cookies with a consent type not allowed by the policy; and
transmitting the modified request.

11. The method of claim 10, further comprising modifying the request to indicate use of the cookie manager.

12. The method of claim 10, further comprising receiving a response to the request wherein the response comprises a list of cookies used to generate the response and a consent type for each cookie used to generate the response.

13. The method of claim 12, further comprising updating a record of the cookie manager to reflect the list of cookies, including the associated consent types, used to generate the response.

14. The method of claim 12, further comprising receiving a modification to the policy from a user, and updating the policy based on the modification to the policy from the user.

15. The method of claim 12, further comprising providing the response, including the list of cookies used to generate the response, to the client.
